(19) United States
(12) Patent Application Publication
(10) Pub. No.: US 2008/0155867 A1
(43) Pub. Date: Jul. 3, 2008

(54) Methods make signs on label for food, drink or medicine products to users make marks which in turns as a result, these methods can make the related-mentioned practice much easier, simplier and better to recognize and/or remember necessary informations

(75) Inventor: Khiem Sy Nguyen, Hayward, CA (US)

Correspondence Address: KHIEM SY NGUYEN, 21845 MISSION BLVD, HAYWARD, CA, 94541, US

(73) Assignee: Ky van Nguyen, Hayward, CA (US)

(21) Appl. No.: 11/647,809

(22) Filed: Dec. 28, 2006

(51) Int. Cl. G09F 3/00

(52) U.S. Cl. 40/310

(57) ABSTRACT

This invention is add extra signs on product label to user can put necessary informations in using process. The signs to define the best time using of product after opening date include number groups, which user can mark date to recognize the expired day after opening date. The signs to define Self-identification of own products among different users to recognize their own previously used thing, include the number and alphabet groups which can describe their name as initial. The signs for management medicine taking process include number lines to mark date when user taking medicine. Those signs help them note their medicine taking previously or earlier, to remind user that their medicine actually were taken or not at that time. Another way to carry out purposes above is design a blank box for writing notes instead of mark on number or alphabet lines.

### CROSS-REFERENCE TO RELATED APPLICATION

Not applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the addition of more signs on label for food, drink or medicine products.

2. Background

The information presently provided on the products' label nowadays is not explaining and/or giving enough instructions to the users, especially during the products' usage process. In the usage process, the users need to know or have the information and/or the related instructions as followed:

1/The date when the products' cap is actually opened:

The reason is that the expired time of the product is counted not only from the issued date but also from the first opening day when the product is opened as some micro-organism, air, moisture and light can probably penetrate into the food and seriously damage them. As a result, this is why some product's notice only mentions: “Use opened-can-contents within 1 month”. Normally, it is hard for the users to remember exactly the date they first open them, and therefore, they often forget them. And thus, they would possibly be going to use a decayed product, or else, they would just discard it by accident, before its actual-expired date.

2/Self-identification of own products among different users to recognize their own previously used thing, such as a can or a bottle, while they are at the same location, place and/or at a table. When there are many people using the same kind of products, food or drinks, as they are in the same location, place, or at the same table, it may be very confusing or hard to tell who has what food or drink: Which one is mine, which one is yours?. Guessing isn't a safe method or a process, as they may catch a disease from someone else unintentionally.

3/Noting-marking the medicine or the medication when it actually is taken. Certainty or knowledge while using some products like medicine medication, and its schedule when to take it, is a very strict, dangerous matter, could be resulted in a life-or-death/serious situation. Furthermore, just simply skipping or taking the medicine twice is also a very dangerous reality for patience-users. The question is often raised among a patience is whether he/she has taken the necessary prescribed pills, instructed by their doctor for the day. This is why they need the assistance of this information on the bottle's label as to know, to recognize and/or to remember the big word “When”, with fair level of certainty and safety.

Background of the Invention's Intented-Objects and Related-Benefits and Advantages Over the Presently Available Practices

Accordingly, several intended-objects related-benefits and advantages of my invention are that, we add the extra information and/or provide the extra instructions by providing the special signs on label to help the users to make the necessary marks directly and easily on the products while in use. These marks will help users solve and/or eliminate all the problems mentioned above.

1/ These new signs on the label can describe and show the date with Number line and the Alphabet line.

a/ Number line includes numbers from “1” to “31”, as it describes each day of a month:

1 2 3 4 5 6 7 8 9 10 11 12 13 14 15 16 17 18 19 20 21 22 23 24 25 26 27 28 29 30 31.

b/ Number line includes numbers from “1” to “12” as it describes each month of year, which in different color with number line of the day.

1 2 3 4 5 6 7 8 9 10 11 12

c/ And for each letter in the Alphabetical order for an user name-initial:

### A B C D E F G H I J K L M N O P Q R S T U V W X Y Z

D/ Number line for year which is in the best using time.

### Ex: 07, 08, 09

These Number line and Alphabet line are generally in use for the 3 intended purposes and related benefits/advantages mentioned above.

2/The blank box for writing necessary notes which are described above instead of using marks on Alphabet or number box lines.

On each produce, producer can make a small blank box on the label, to user can write down necessary notes. The blank box is just blank area which user can use pen, pencil or other thing to notes some information for reminding or remember something. In the blank box they can write the cap opening date or user's initial.

### GENERAL APPLICATION OF THE NEW METHODS AND ITS SIMPLE PRACTICES

### 1/How to Make the Signs

There are many ways to produce the intended signs on the products' label:

a/Print two layer-line of the number-line for (1a), and for the Alphabetical-line for (1b) and (1c) above, on the same product's position

The surface line has and is printed with one color, and is different the one in the under line. The surface line could be scratched easily by the users (Just like a lotto ticket). When an user chooses a letter for making a mark, letter A for example, on the chart-line (1b) or (1c) above, the user just has to find the letter A, and then makes the mark by scratching right on it. Now the letter A is marked and the selection process is done and made. Other selection method for a number and for an Alphabetical month and name's initial follows the same practice and/or application.

b/ Another possible printing method is making two lines: one line above is for the surface line for (1a), (1b) and (1c), and the under-line is right below it. The user just has to find the proper spot below to scratch and the mark is simply made or done.

c/ Making special blank box: the blank box also is painted with special paint or it is covered with wax which is easy to be scratch, so that users can write notes down to this box by any thing; like pen, pencil, stick, fingernail etc.

### 2/Direction Application and Practical Instructions for Products' Users

Again, the way the users can make marks on Number line and Alphabet line is to use the information in their daily life. Depending on a different kind of products, any user can choose the best way to make the marks on label.

### a/ Date Marking

This one is to recognize and remember the expiration date of the product, depending on opening date the user presently needs to make for the mark on the product's label. Users can choose the line number for marking the day of the month, and the Alphabet letter for month.

### b/ Self-Identification of Own Products

Users can make their marks at Alphabetical line for their initials. If they worry that there are someone else with the same name-initial, they can choose more letters or extra numbers.

c/Controlling Medicine Taking or Proper-Timely Usage

Using Number-line and Alphabet-line to assist and remind the users how to take the medicine or the medication daily is very necessary and important, as each time the medicine is taken, the users would make a mark immediately right on the date they actually do it.

This invention helps to make the signs and marks on the various, different products' label, for the users would have the procedure, the methods and the instruments to help them noting their medicine taking previously or earlier, by just simply checking and looking at these signs and/or remarks on the label. Another Number line would be added if the user needs to take the medication many times a day.

### Conclusion:

The invention for providing these methods to the users to make simple signs and thus, is to easily recognize certain marks and/or remember the necessary, important information, and/or follow the intended instructions on the products' label, such as on the packaging box, can, bottle for food, a drink or on the medicine products. Furthermore, the users can also make the marks to find out exactly and then, pick up correctly their own previously used thing, such as a can of soft drink or a bottle of beer, while they all are in the same location, in the same place and/or at the same table with other people. In the end, the consumers will and should welcome this invention, because it will make their daily life with other family members and close friends, more convenient, more quickly, more accurately, with minimum-simple effort for greater and safer for one's own health-issue protection, for one's own thinking/reminding/selection process. These intended benefits and related advantages are tremendous, as they are really considered as multi-usages and multi-dimensions.

### DRAWINGS—FIGURES

FIG. 1: Sign for marking of product's cap opening date. It shows the label of the package with its three number groups.

These three number groups show the Number boxes with a two-layer. The surface boxes are printed with one color, and are different from the one in the under-inside line. The surface line could be scratched easily by the user's finger-nail tip (Just like scratching a lotto ticket.)

a/ Line-Detail #1: The Number's group shows what is the day of month.
b/ Line-Detail #2: The Number's group shows what is the month of year.
c/ Line-Detail #3: The Number's group shows what is the year

FIG. 2: Sign for self-identification of own product, It explains further the Line-Detail #2 and the Line-Detail #3, and right below Line-Detail #2 is the Line-Detail #3, they are square-or-box line for the user to find the proper spot for making the marks.

a/Group-Detail #1 and Line-Detail #2: The Alphabets shows what is the user's name-initial. They are made same way the number group in FIG. 1.
b/Line-Detail #3: they are square-or-box line for the user to find the proper spot for making the marks.

FIG. 3: Noting-marking the medicine or the medication when it actually is taken. This form for taking many times in day

a/Line-Detail #1: Show what are the days of month. They for taking one time a day.
b/Line-Detail #2: Show what is times in day and what is days of month.

FIG. 4: The blank box, it for noting of user.

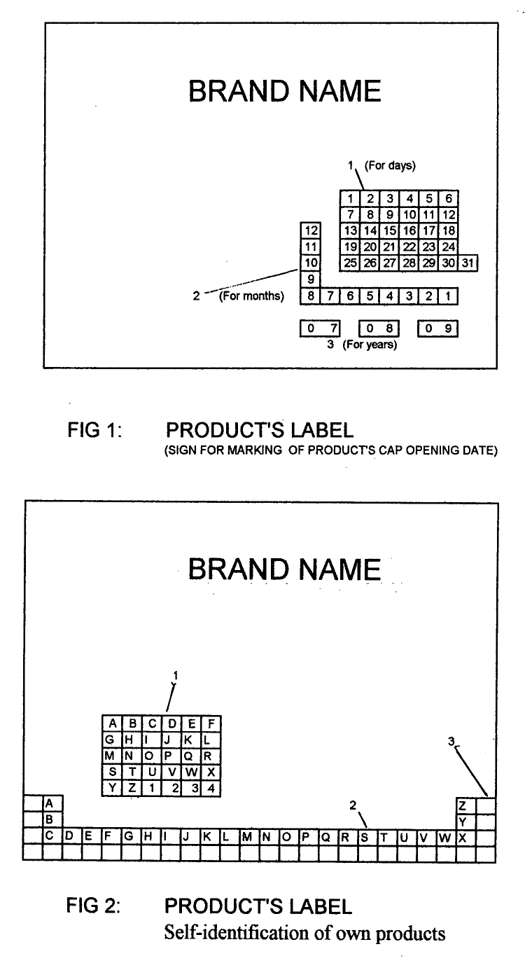

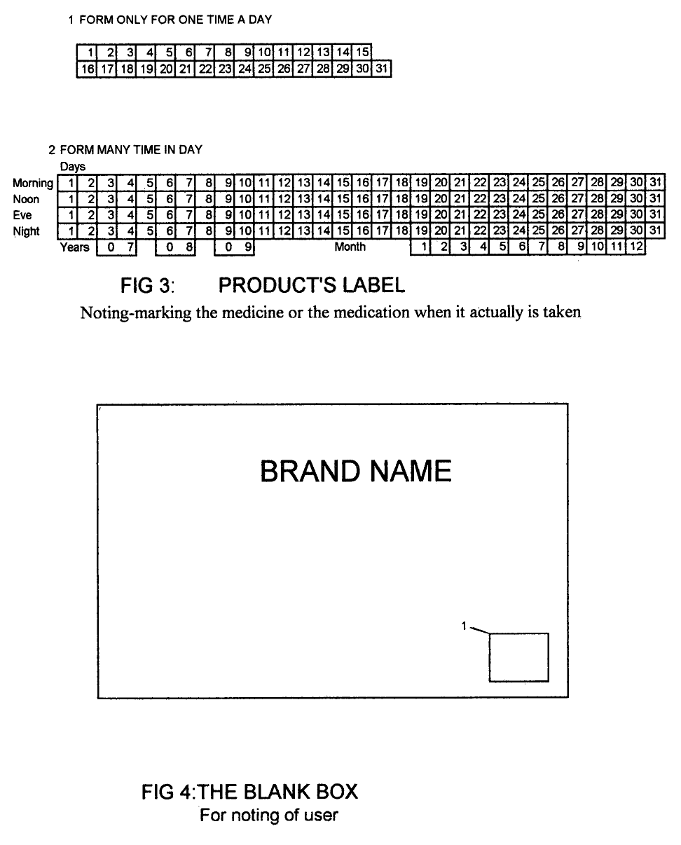

Line-Detail #1: Show the blank box in the label

I claim:

1. The addition of more signs on label for food, drink or medicine products for users to make the marks which in turns as a result, these methods can help recognize and/or remember: the date when the product is first opened, the user's name-initial or, the time when the medicine/the medication was taken previously or earlier, by just simply checking and looking at these signs and/or remarks on the label in the using process.

2. The extra signs of claim 1 wherein said the method mark to remember the first day of opening product's cap or also is marked by the expired day which is counted from the day of cap opening, they is depended on producer.

3. The extra signs of claim 1 wherein said method make a blank box on the label to user can write down necessary notes as the cap opening date or user's initial, and this blank box is special box which can write notes with a solid pointed thing like; pen, pencil, nail, fingernail, etc.

4. The extra signs of claim 1 wherein said the sign marking methods are shape change or color, right on signs or the area next to signs to recognize signs were marked, and these sign marking methods how to users can use own fingernail's tip to scratch, tear or peel them off easily and quickly like making hole line.

5. The extra signs of claim 1 wherein said the sign making methods include; print two layer-line of the number-line and Alphabetical-line on the same product's position and the surface line has and is printed with one color, and is different the one in the under line, moreover the surface line could be scratched easily by the users (Just like a lotto ticket), another possible printing method is making two lines: one line above is for the surface line include number or alphabet line and the under-line is right below it which for marking, in this case the user just has to find the proper spot below to scratch and the mark is simply made or done.

6. The sign marking methods of claim 5 wherein said these methods are to use the Numbers' and/or Alphabets' lines, and can also be adapted with any internationally popular languages in the world, other than in English, or with any other kind of simple symbols or of different colors.

7. The sign marking methods of claim 5 wherein said the sign making method in some products is made under line below number or alphabet lines, which can be covered with wax or thin plastic to user can make marks easily by the way tear or scratch them.
